(19) United States
(12) Patent Application Publication
(10) Pub. No.: US 2011/0224997 A1
(43) Pub. Date: Sep. 15, 2011

(54) URBAN INFORMATION SYSTEM

(76) Inventors: Pavel Khazanov, Bat-Yam (IL); Pavel Vilensky, Bat-Yam (IL)

(21) Appl. No.: 12/720,742

(22) Filed: Mar. 10, 2010

(51) Int. Cl. G06F 15/16; H04B 7/00; G01C 21/00; G06Q 30/00

(52) U.S. Cl. 705/1.1; 455/41.2; 455/500; 701/213; 709/204

(57) ABSTRACT

An urban information system comprising a server connected via a specified wireless network to stationary information devices operable by users, and to mobile information devices associated with service providers. The system provides the users with information relating to city infrastructure and to services of the service providers, and allows a visual direct and interactive connection between the users and the service providers.

### BACKGROUND

1. Technical Field

The present invention relates to the field of information systems, and more particularly, to an urban information system.

2. Discussion of Related Art

As tourism expand ever more globally, the need constantly increases for reliable and comprehensive urban information systems, that allow tourists as well as locals to find information and services in the cities.

### BRIEF SUMMARY

Embodiments of the present invention provide an urban information system comprising: a server comprising a plurality of databases with information relating to city infrastructure and to services of a plurality of service providers; a plurality of stationary information devices connected via a specified wireless network to the server, each stationary information device comprising a display, a GPS module, a plurality of communication appliances, a graphical user interface and a database comprising geographic information and city related information received from the server, the stationary information devices arranged to provide information interactively to a plurality of users; and a plurality of mobile information devices connected via the specified wireless network to the server and to at least one of the stationary information devices, the mobile information devices associated with the service providers and arranged to allow communication of the service providers with the users, wherein the stationary information devices are arranged to provide the users with information relating to the service providers, wherein the mobile information devices are arranged to provide the service providers with information relating to the users, and wherein the stationary information devices and the mobile information devices are arranged to generate visual communication between the users and the service providers.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of an urban information system, according to some embodiments of the invention; and

FIG. 2 is a high level flowchart illustrating a method, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

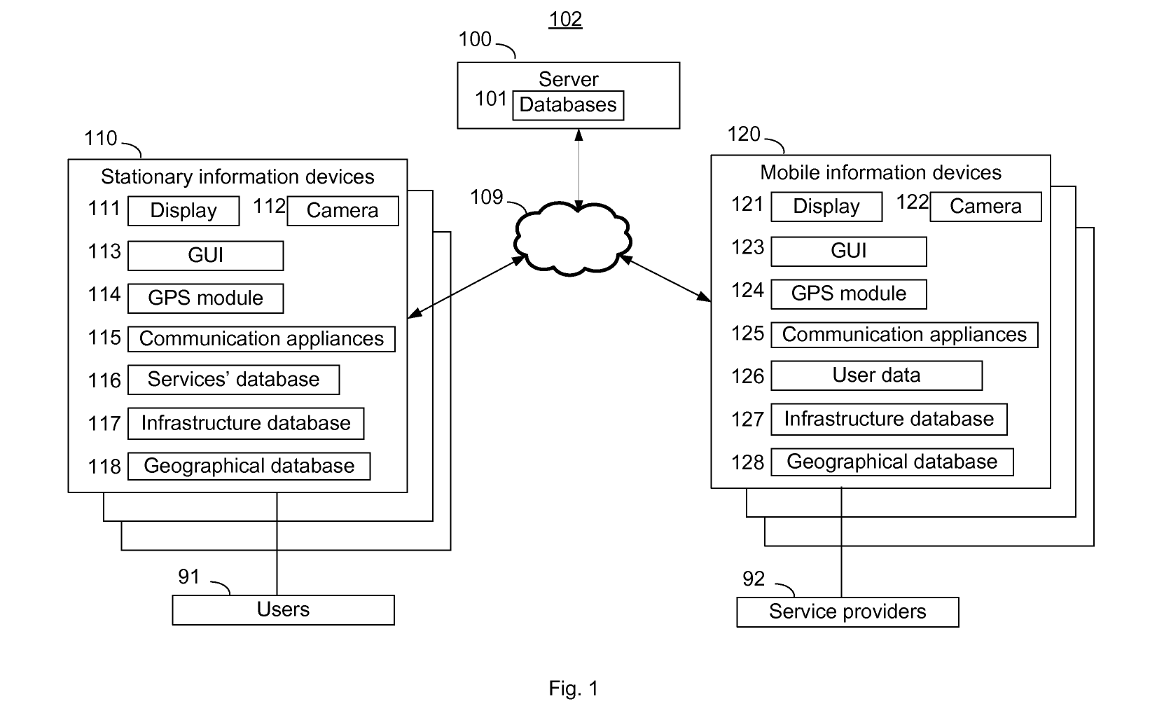

FIG. 1 is a high level schematic block diagram of an urban information system 102, according to some embodiments of the invention. Urban information system 102 comprises a server 100 comprising a plurality of databases 101 with information relating to city infrastructure and to services of a plurality of service providers 92.

Urban information system 102 further comprises a plurality of stationary information devices 110 connected via a specified wireless network 109 to server 100. Each stationary information device 110 comprising a display 111, a GPS module 114, a plurality of communication appliances 115 (such as a microphone and a speaker, a camera 112 and a display or a display area on display 111), a graphical user interface (GUI) 113 and databases comprising geographic information 118 and city related information 117 received from server 100. Stationary information devices 110 are arranged to provide information interactively to a plurality of users 91, e.g., they may be set at various locations in the city and be designed in a very user friendly manner. Furthermore, stationary information devices 110 are arranged to provide users 91 with information relating to service providers 92, e.g., as a services' database 116.

Stationary information devices 110 may present user 91 information relating to: business, shops, restaurants, cinemas, hotels, bars, police stations, hospitals, gas stations, governmental buildings, educational institutes, public transportation, weather, news, emergency services, etc. The information may be displayed visually on display 111, and may allow user 91 to interactively explore the information via GUI 113. Each stationary information devices 110 may have a unique ID.

Stationary information devices 110 may allow users 91 search through databases 116, 117, 118 and correlate information from various databases on a common geographical basis.

Urban information system 102 further comprises a plurality of mobile information devices 120 connected via specified wireless network 109 to server 100 and to at least one of the stationary information devices 110. Mobile information devices 120 are associated with service providers 92 and arranged to allow communication of service providers 92 with users 91. Mobile information devices 120 are arranged to provide service providers 92 with information relating to users 91, e.g., as user data database 126. Each mobile information devices 120 may have a unique ID.

Each mobile information device 120 comprising a display 121, a GPS module 124, a plurality of communication appliances 125 (such as a microphone and a speaker, a camera 122 and a display or a display area on display 121), a graphical user interface (GUI) 123 and databases comprising geographic information 128 and city related information 127 received from server 100.

Mobile information devices 120 may present service providers 92 information relating to: business, shops, restaurants, cinemas, hotels, bars, police stations, hospitals, gas stations, governmental buildings, educational institutes, public transportation, weather, news, emergency services, etc. The information may be displayed visually on display 121, and may allow service providers 92 to interactively explore the information via GUI 123. Mobile information devices 120 may further present user data, such as activation and occupation of stationary information devices 110 and actions and browsing data of users 91 operating stationary information devices 110.

Stationary information devices 110 and mobile information devices 120 are arranged to generate visual communication between users 91 and service providers 92. Through the visual communication, users 91 and service providers 92 may coordinate service provision. Examples are: finding and ordering a taxi, buy tickets to shows and events, interactive advertizing, receiving further information, e.g., directions and connections.

Specified wireless network 109 may be fast and secure, independent from public communication networks such as the Internet and cellular networks.

Stationary information devices 110 may comprise a payment unit, arranged to bill users 91 for the received information or for usage of stationary information devices 110. GUI 113 may comprise an instruction module, that may be enhanced by a connection with a service center via communication appliances 115.

Stationary information devices 110 and mobile information devices 120 may comprise a Bluetooth connection for communicating with communication devices of users 91 and service providers 92.

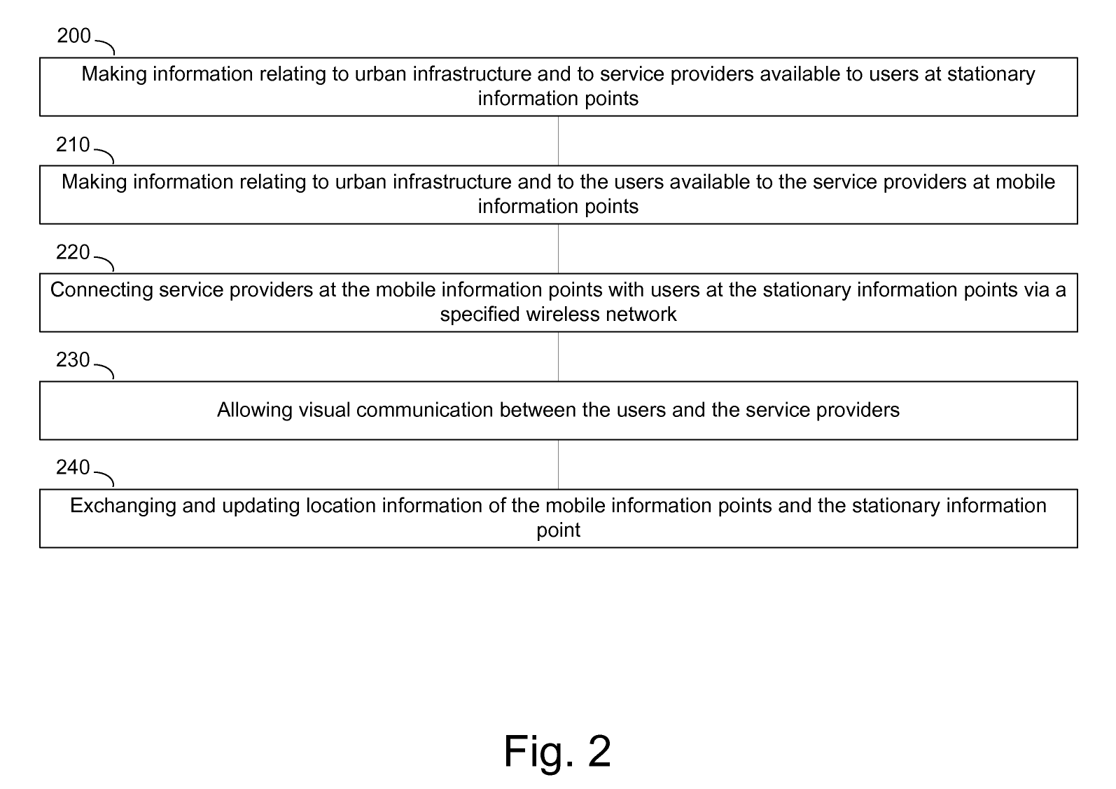

FIG. 2 is a high level flowchart illustrating a method, according to some embodiments of the invention. The method comprises the following stages: making information relating to urban infrastructure and to service providers available to users at stationary information points (stage 200); making information relating to urban infrastructure and to the users available to the service providers at mobile information points (stage 210); and connecting service providers at the mobile information points with users at the stationary information points via a specified wireless network (stage 220). The method may further comprise the stages: allowing visual communication between the users and the service providers (stage 230); and exchanging and updating location information of the mobile information points and the stationary information point (stage 240).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An urban information system comprising:
a server comprising a plurality of databases with information relating to city infrastructure and to services of a plurality of service providers;
a plurality of stationary information devices connected via a specified wireless network to the server, each stationary information device comprising a display, a GPS module, a plurality of communication appliances, a graphical user interface and a database comprising geographic information and city related information received from the server, the stationary information devices arranged to provide information interactively to a plurality of users; and
a plurality of mobile information devices connected via the specified wireless network to the server and to at least one of the stationary information devices, the mobile information devices associated with the service providers and arranged to allow communication of the service providers with the users,
wherein the stationary information devices are arranged to provide the users with information relating to the service providers,
wherein the mobile information devices are arranged to provide the service providers with information relating to the users, and
wherein the stationary information devices and the mobile information devices are arranged to generate visual communication between the users and the service providers.

2. The urban information system of claim 1, wherein the communication appliances of the stationary information devices comprise at least one of: a microphone; a speaker, a camera; a display; and a display area.

3. The urban information system of claim 1, wherein the database in the stationary information devices comprises data relating to at least one of: businesses; shops;
restaurants; cinemas; hotels; bars; police stations; hospitals; gas stations;
governmental buildings; educational institutes; public transportation; weather; news;
and emergency services.

4. The urban information system of claim 1, wherein the stationary information devices is arranged to provide the information visually on the display.

5. The urban information system of claim 1, wherein the user interface of the stationary information devices is arranged to allow the user to interactively explore the information.

6. The urban information system of claim 1, wherein each of the stationary information devices and each of the mobile information devices has a unique ID.

7. The urban information system of claim 1, wherein the mobile information devices comprise at least one of: a microphone; a speaker, a camera; a display; and a display area.

8. The urban information system of claim 1, wherein the database in the mobile information devices comprises data relating to service providers associated with at least one of: businesses; shops; restaurants; cinemas; hotels; bars; police stations; hospitals; gas stations; governmental buildings; educational institutes; public transportation; weather; news; and emergency services.

9. The urban information system of claim 1, wherein the stationary information devices and the mobile information devices are arranged to allow the user carry out at least one of: finding and ordering a taxi; buy tickets to shows and events; interactive advertizing; and receiving information.

10. The urban information system of claim 1, wherein the specified wireless network is independent from public communication networks.

11. The urban information system of claim 1, wherein the stationary information devices further comprise a payment unit arranged to bill users.

12. The urban information system of claim 1, wherein the stationary information devices and the mobile information devices further comprise Bluetooth connection for communicating with communication devices of the users and the service providers, respectively.

13. A method comprising:
making information relating to urban infrastructure and to service providers available to users at stationary information points;
making information relating to urban infrastructure and to the users available to the service providers at mobile information points; and
connecting service providers at the mobile information points with users at the stationary information points via a specified wireless network.

14. The method of claim 13, further comprising allowing visual communication between the users and the service providers.

15. The method of claim 13, further comprising exchanging and updating location information of the mobile information points and the stationary information point.
